(19) United States
(12) Patent Application Publication
(10) Pub. No.: US 2019/0127063 A1
(43) Pub. Date: May 2, 2019

(54) THREE DIMENSIONAL SCALABLE AND MODULAR AIRCRAFT

(71) Applicant: BURAK GOZLUKLU, Cambridge, MA (US)

(72) Inventor: BURAK GOZLUKLU, Cambridge, MA (US)

(21) Appl. No.: 16/094,377

(22) PCT Filed: Apr. 11, 2017
(86) PCT No.: PCT/TR2017/050136

§ 371 Date: Oct. 17, 2018

(30) Foreign Application Priority Data
Apr. 22, 2016 (TR) 2016/05215

(51) Int. Cl. B64C 37/02; B64C 29/00; B64C 39/02

(52) U.S. Cl. CPC B64C 37/02; B64C 29/0033; B64C 2201/143; B64C 2201/027; B64C 2201/108; B64C 39/024

(57) ABSTRACT

A three-dimensionally scalable, modular and customizable aircraft composed of stably flyable plurality of planar unitary systems which provides a coordinated thrusting vector in any direction of the three-dimensional space. The aircraft includes at least one circumferential frame that surrounds the system in one plane that houses at least one rotatable piece that allows the system to rotate around at least one rotation axis relative to the circumferential frame. The aircraft includes at least two assembly regions located on the external surfaces of the circumferential frame which is used to attach at least two adjacent modules by touching each other, and also includes at least two electrical power transmission regions that are aligned with the corresponding identical region of the next module which allows sharing of the power sources providing energy to the system among all of the modules.

### TECHNICAL FIELD

The present invention presents a reliable and customizable vertical take-off, flight and landing aircraft which is scalable and modular in the three-dimensional space.

### PRIOR ART

Today, rotor propelled unmanned drones (VTOLEPUD) capable of taking off vertically, flying in all three-axis and landing, are started to be frequently used in emergency situations, surveying, and observation purposes. Another example of an application of drones is to transport packages between different locations. Considering the diversity of the weights of the packages, the fleet should include drones with various load carrying 15 capacities (maximum takeoff weights). Therefore, this invention proposes a unitary “worker drone” design that can assemble itself with other unitary worker drones in all three-dimension to increase the load carrying capacity as well as improving reliability.

Especially in the United States, online retailers are planning to modify their businesses towards using drone systems to deliver the orders. The packages to be delivered would be unavoidably in different sizes and weights. This is the reason why some retailer companies plan to operate drones in various capacities, which is not economical regarding the inventory costs of the fleet. Another conventional solution is to operate single sized drones, which is capable of carrying the heaviest allowable package. However, in this case, employment of high capacity drones in carrying small packages would be more expensive regarding the operation costs. Consequently, the best model is to command a fleet composed of unitary worker drones which can both singly operate to carry light and small packages or be modularly scaled to have larger drones which improve the weight carrying capacity in the increments of a single drone based on the package weight and size. Scalability in 3D provides a better load distribution among the assembled drones, which results in better flight dynamics, versatility and reliability of the whole system, compared to a 2D configuration. In the prior arts, 2D scalability or the scalability solely based on the propellers do not provide the same performance characteristics and reliability which are all accomplished by our invention.

Recently, the increasing number of practices in drone industry persuaded airworthiness regulators; such as Federal Airworthiness Authority (FAA), to settle restrictions on the drone operations due to the misuse and low reliability of the system. The currently presented invention provides a “fail-safe” solution to enhance the reliability of the whole system significantly. Damage to a propeller or failure of a single worker drone in a 3D formed flying assembly do not lead to catastrophic failure of the entire system since the modularly scaled aircraft is composed of inherently stable systems. This further helps to get adequate permission from the authorities in the future due to the achieved fail-safe compliance in this invention.

One of the similar drone systems is the US patent of US20110226892A1, which presents a plurality of assembled tilted propellers, so-called “modules” by US20110226892A1. The modules are utilized to provide the desired thrust and moment to the flying system. The tilted propellers can rotate on at least three planes, which improves the maneuverability of the vehicle. At first glance, it can be easily noticed that the patent of US20110226892A1 has a different architecture by assigning the propellers as the modules to be scaled in the system. This fact makes the vehicle unstable in case of a loss of the propellers since each propeller is not inherently stable due to the angular momentum created by the added propeller should be balanced. Due to the fact of losing one of the propellers may lead to loss of the total control, US20110226892A1 required the symmetry condition for the modules of propellers. On the other hand, our invention does not require any global symmetry or any global geometrical condition that is necessary to keep the stability of the aircraft thanks to the intrinsically balanced angular momentum of each module in our invention.

An aircraft formed by connecting stable independent modules can be found in US20120179308A1. In this document, each module is able to fly alone using their four propellers. The vehicle is connected by attachment of the constituent flying units within a single plane that create different configurations in two-dimensional space. However, connectivity within in a single plane cripples the variety of possible applications and maneuverability of the resulting aircraft. For US20120179308A1, the lack of modules on the planes that are orthogonal to the mutually connected plane of two modules does not allow formation of 3D systems, which strongly reduce the load carrying capacity of the aircraft. Due to the same reason, the addition of modules in 2D plane to have the adequate thrusting force would lead to an assembled aircraft filling a large surface on air, which eventually creates a burden on the operational actions. The same property does not allow the whole system carrying larger loads that means that the resulting system is not purely scalable due to the resulting constraints in the architecture of the design.

Another drone system is disclosed in WO2016027942A1, which discloses a reconfigurable drone system which is capable of being horizontally flown without a rotation motion of the drone. Said system has unit module drones and rectangular parallelepiped shaped structure that may apply thrusts in six directions and is capable of being flown singly or flown in various shapes by forming an assembly drone by coupling between the unit module drones. Said system has propelling parts formed in six directions and generating thrusts in each of the six directions are formed, such that horizontal movement in the six directions is possible to allow rotation motions such as rolling, pitching, and yawing. However, said document is silent about a stable flight in horizontal and also in vertical directions. The reason is due to the architecture of the WO2016027942A 1 that has more than typical number of propellers that are rigidly connected and closely packed next to the motor located at the centroid of which stability control would be hard. An important highlight is the rigid connection between the flyable part and the surrounding airframe that makes the system quite unstable as each stabling control, especially moments, exerted from the propeller directly reflected to the airframe as a disturbing force. In real-life scenarios, the drone systems are operating under winds or air currents, where the system is expected to freely tilt and self-balance. This is one of the reasons why conventional quadrotor drones are very successful. However, highly packed multiple propellers rigidly located inside the centroid as seen in WO2016027942A1 would not produce such a balancing flexibility under external disturbances. WO2016027942A1 is expected to have this balancing once another system is attached. Having, due to the motor location and direct attachment to the motor, the propellers are inevitable located closer to the airframe which leads to reduction in aerodynamic efficiency when another system assembled. Moreover, having one propeller in each direction would reduce the thrusting power which is proportional to the disc area of the propeller. Or using a bigger motor is required for WO2016027942A1 to power many propellers that can reduce the efficiency.

Another application is exhibited in DE102005061741A1 patent that explains a modularly scaled aircraft, built by symmetrically assembled propellers. As discussed in the US20110226892A1 patent, the symmetry condition constitutes reliability and versatility problems. Along with the symmetry requirement, the modularity solely achieved by the propellers lessening the flexibility in the modular and scalable aircraft design. A similar patent is presented in EP2121439B which proposes the plurality of propellers positioned in various angular formations. Since EP2121439B's modularity is depending on the propellers (rotors), the issues previously mentioned for DE1020050617 41A1 and US20110226892A1 are also applicable to this patent, too.

The general application includes a plurality of drones in swarm configuration such that many drones freely fly and operate to perform a single task in accord. Nevertheless, in those applications, the drones are not physically connected to each other because this method is not a good solution for heavy duty (carrying a heavy payload) applications. For instance, the physical connection helps to cancel out internal forces in the orthogonal direction relative to the payload. In a free state, each drone needs to resist the lateral forces by more thrust, which drains more energy and sometimes impossible to pursue. Moreover, a fully and rigidly physical connection, such as in US20120179308A1, problems with maneuverability arise. Our invention, on the other hand, solves all of the preceding problems.

### BRIEF DESCRIPTION OF THE INVENTION

The current invention proposes an aircraft composed of at least two systems in which each subsystem is capable of remotely controlled, stably taking off and landing vertically, and includes at least two propellers which are coordinated with the whole system. The developed aircraft includes a centrally located system which is surrounded by at least one axis passing through the circumferential frame of which outside surfaces include minimum two assembly regions that allow at least two adjacent modules to be assembled in all three orthogonal planes of space and at least two Power transmission regions that coincide with the other modules Power transmission region that enables to share at least one power source center by all modules.

The invented aircraft is made of orthogonally and physically connected adjacent modules where each module is a stable aircraft that can vertically and horizontally fly, and each module has vertical take-off and landing capability and the rotational degrees of freedom with respect to its circumferential frame. These features enable the resulting assembled aircraft highly stable flying vehicle and flexible design that can be configured to have various 3D geometries in rectilinear box settings which improve the maneuverability by deliberately positioning the thrust vectors in the assembled vehicle powered by individual modules. Along with the maneuverability and reliability improvements, the proposed aircraft can adopt additional hardware to be assembled on the system via the readily available connection regions, which result in a truly functional and cost effective solution.

### OBJECTIVES OF THE INVENTION

The objective of this invention is to build an unmanned vehicle that can be remotely controlled.

Another objective of this invention is to provide one module that can stably fly in all directions, can perform vertical take-off and landing.

Another objective of this invention is to obtain both 2D and 3D configurations of aircraft when the modules are attached.

Another objective of this invention is to develop a fail-safe aircraft obtained by attaching modules of which architecture also allows a safe flight following a failure of at least one of the modules during the flight.

Another objective of this invention is to obtain an efficient aircraft with increased endurance by sharing of power sources among the modules.

Another objective of this invention is to obtain a highly versatile aircraft where individual systems can freely rotate relative to each other for providing thrust in any direction.

Another objective of this invention is to develop a highly maneuverable, cost-effective, customizable and safe aircraft.

Another objective of this invention is to obtain an aircraft made of physically connected modules that form three-dimensionally customizable cage system that inherently cancels out all internal forces, provides better load distribution and increases the bending stiffness, which facilitates the system to be used in transporting heavy loads.

Another objective of this invention is to modularly construct an aircraft resembling a three-dimensional rigid system where the locations of constituent systems can be positioned to design a spatially distributed vector thrust field where an individual system can provide a thrust in any direction that can continuously change during the fight.

Another objective of this invention is to have a platform that facilitates a wide variety of additional electro-mechanical hardware

### EXPLANATIONS OF FIGURES

Examples of several applications of the invention are presented in the following figures;

FIG. 1; Perspective view of a single module of the invention

FIG. 2; Perspective view of the invented aircraft formed by attachment of four modules providing a 3D flying assembly in a box configuration.

FIG. 3; Perspective view of the invented aircraft formed by attachment of three modules and couple of specialized attached hardware.

FIG. 4; Perspective view of the invented aircraft formed by attachment of ten modules and a large plate that create a versatile flying platform.

FIG. 5; Perspective view of a single module of the invention with a circular secondary electrical power transmission region.

The parts in the figures are numbered and defined as follows;

| Aircraft | (V) |
|---|---|
| Module | (M) |
| Propulsion System | (S) |
| Propeller beam | (S1) |
| Propeller | (P) |
| Circumferential Frame | (1) |
| Central piece | (1a) |
| Assembly region | (1b) |
| Electrical connection region | (1c) |
| Power source | (1d) |
| Secondary electrical power transmission region | (1e) |
| Additional piece | (1f) |
| Hardware | (2) |
| Plate | (3) |

### DESCRIPTION OF THE INVENTION

Rotor-based unmanned drones started to be widely used in transportation, emergency, and surveying operations. The drones should be in various configurations and have different capacities designed for different missions where the drones are specialized. In the prior art and publicly available products of drones, their applications are usually limited due to specialized design of the particular drone product. Hence, it is necessary to develop a customizable aircraft that can be modified according to the function, allowing a broad diversity of ameliorative features and adaptive to the conditions where the system operates. A physically and electrically connected system made of multiple freely rotatable and stable drone systems forming a 3D structure would be the core of this invention.

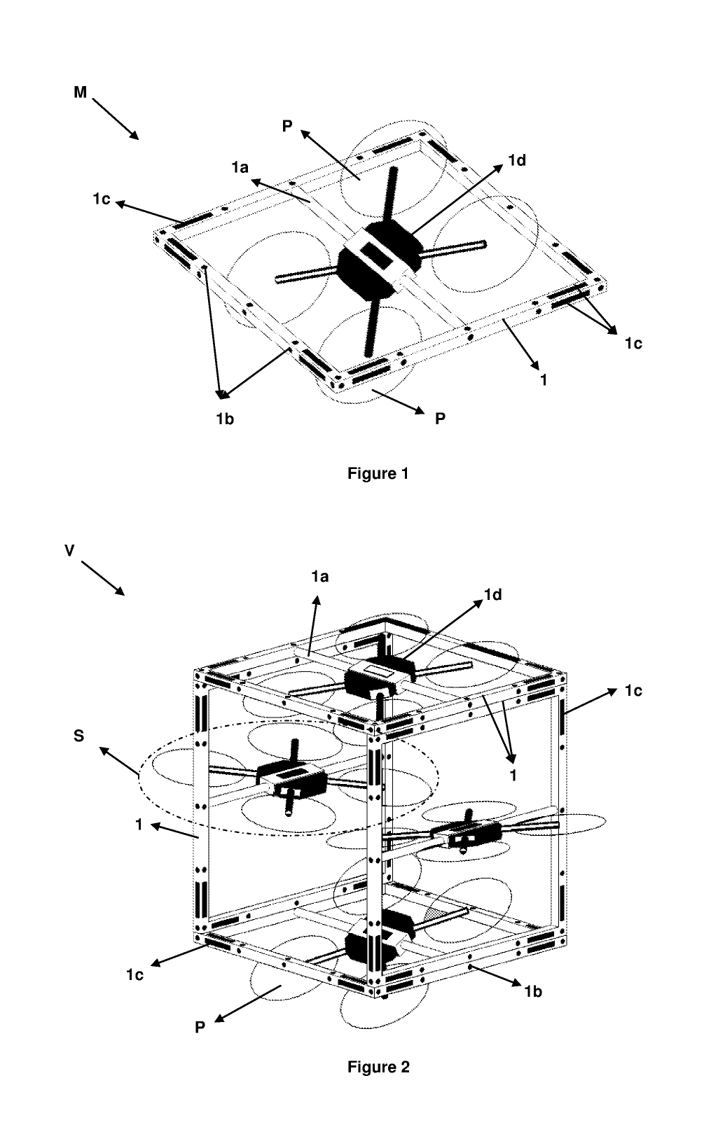

An example of the proposed aircraft (V) is shown in FIG. 1, where the aircraft (V) is capable of being remotely controlled or automatically controlled. The aircraft (V) is made of at least two propulsion systems (S) that can solely fly stably in both vertical and horizontal directions and each propulsion system (S) containing at least two thrust propellers (S1) coordinated with the remaining of the aircraft (V). The invented aircraft (V) is enclosed by at least one circumferential frame (1), expected to be made of light-weight carbon fiber reinforced composite materials (CFRP), which centers the propulsion system (S) and allowing a relative rotation to the enclosed propulsion system (S). To do that, the invented aircraft (V) embodies at least one central piece (1a) connected to the circumferential frame (1) that houses the plane of the rotation axis for the central piece (1a) which can freely rotate with respect to the circumferential frame (1). A circumferential frame (1) comprises at least two assembly regions (1b) that face outside of the propulsion system (S) and used to physically attach at least one adjacent modules (M) which would eventually build 2D/3D structural cage system made of orthogonally assembled circumferential frames (1). The net thrust vector is produced by the individual but synchronized thrusts of each propulsion system (S) which can freely rotate with respect to the resulting aircraft (1) cage structure to maneuver. The circumferential frames (1) have at least two electrical connection regions (1c) that transfer the power from the power source (1d) on the propulsion system (S). In that way, the total power is shared among the attached modules (M) of which assembly resembles a fully connected grid system made of multiple electrical connection regions (1c) and power sources (1d). The successive assembly of modules (M) can be used to scale the propulsion systems (S) in all three orthogonal directions that create a 3D aircraft (V) which is structurally connected in terms of power, physical and information operands. The connections in all of the three orthogonal planes are enabled by the free rotation of the propulsion system (s) thanks to the central piece (1a) and allocation of the transfer regions (1b,1c) in all outside faces of the circumferential frame (1). Each propulsion system (S) is expected to include conventional batteries, control systems, gyroscopes and electric motors that are expected to connect to the power sources (1d). The control computers of the modules (M) are expected to be in continuous wireless communication where the thrust and angle of systems can be synchronized. The synchronization of the module propellers (P) (thrusts) would be easier since the locations of the modules (M) are fixed due to the homogeneous distribution of the propulsion systems (S) inside the cage propulsion system formed by the circumferential frames (1).

An example of an application of the invention incorporates multiple modules (M) attached to each other via the assembly regions (1b). At this condition, the electrical connection regions (1c) are also touching to each other, which also allows transferring the power from power sources (1d) via the electrical connection (1c) to the modules (M) that drain more energy. The resulting network of transmission regions (1b,1c) and circumferential frames (1) can also be used to attach different electro-mechanical hardware (2) to the aircraft (V). The aircraft (V) formed by repetitive 3D attachment of the modules (M) includes freely rotatable propulsion systems (S) pivoting around the central piece (1a). The aircraft (V) made of translationally fixed but rotationally free stable propulsion systems (S) would result in highly maneuverable, fail-safe and heavy duty aircraft (V). The reason for the maneuverability is the free rotation, but fixed locations of drones. This mechanical and geometrical property assign different moment arms to each propulsion system (S) with respect to the center of mass of the aircraft (V). The fail-safety feature is due to the robust compensation of a failed propulsion system (S) by the remaining propulsion systems (S) since individually flyable propulsion system (S) having more than two propellers (P) can quickly adapt to the new dynamics of the aircraft (V) right after the failure. The ability to carry heavy loads is the summation of the thrusts provided by each propulsion system (S) while internal balancing of the secondary lateral loads throughout the cage propulsion system made of the circumferential frames (1). The critical feature is the involvement of the central pieces (1a) that facilitates independent rotation to each propulsion system (S) which can adjust its angle of rotation and thrusts in agreement with the other modules (M). Noting that, the propulsion system also employs the conventional rotation capability which is achieved by controlling the spinning of the propellers (P) that rotate the whole vehicle (V) with the conservation of angular momentum. The geometry of the aircraft (V) can be also configured by the different spatial combination of modules (M) that have the connection regions (1b,1c) distributed along all of the edges of the circumferential frames (1). Theoretically, the maximum take-off weight or the maximum load carrying capacity of the aircraft (V) is proportional to the number of modules (M). Nevertheless, the air blows of the propellers (P) may reduce the carrying capacity of the propulsion systems (S) staying under the blow. The efficiency loss is caused by the disturbed aerodynamic airflow on the propellers (P) of the downside propulsion systems (S). The efficiency loss is not expected to be greater than 30% which has been studied extensively for contra-rotating propellers used in helicopters. In summary, even though the inclusion of extra modules certainly increases the load carrying capacity of the aircraft (V), it is not linearly dependent but increasing with an inefficiency factor based on the distance between the adjacent modules (M), propeller (P) size, thrust value and configuration. The major advantage of module (M) assembly is coming from the creation of a 3D truss propulsion system. A heavy point load carried under the center of gravity of the aircraft (V) would generate internal lateral forces as a result of different loading angles for the propulsion systems (S) staying outside of the center of the gravity. Such internal forces are canceled out inside the truss propulsion system (S). As mentioned in the first chapter, the conventional application of using multiple free drones to carry a load require employing extra thrust by propellers (P) to cancel out these lateral internal loads, which is inherently solved by the proposed invention.

In another application of the invention, the aircraft (V) includes flyable propulsion systems (S) in that at least three propellers (P) are joined via at least one propeller beam (S1) that connects the centers of the propellers (P). In this application, the power source (1d) is located at the center of the propulsion system (S) which is the place where the propellers (P) are met via their propeller beams (S1) that determines the center of gravity of that propulsion system (S). In another application of the aircraft (V), there are four propellers (P) that are located at the corners of a square that are all met at the center of the propulsion system (S) where the power source (1d) is also located. Keeping the center of gravities near the geometric center of the circumferential frame (1) would help to obtain a more stable aircraft (V) once they are assembled. Noting that, it is expected to have at least one gear propulsion system (S) between the propeller (P) and the motor that drives the spin speed.

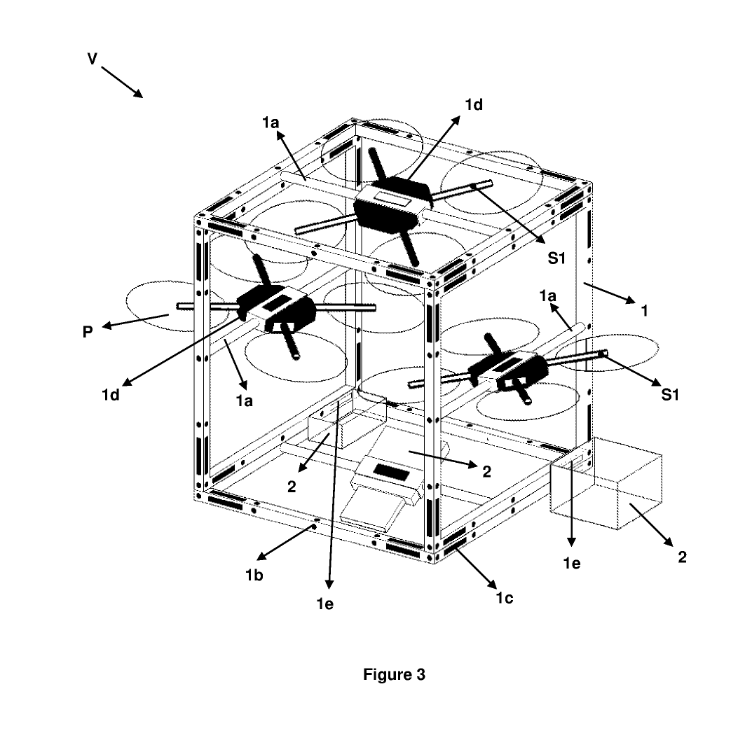

In an application shown in FIG. 3, at least one hardware (2) is attached to the connection regions (1b,1c) which stays outside of the vehicle boundary while another extra hardware (2), such as an additional power source (1e), is located inside the vehicle (V), at the center of the propulsion system (S) of which constitutes, other than circumferential frame (1) and central piece (1a), are removed. These hardware (2) can be storage tank, battery, camera, spraying propulsion system or any electro-mechanical hardware. Due to the central pieces (1a) and other modules (M) that are currently active to maneuver the aircraft (V), the current propulsion system would be very stable. Especially, the current invention would be highly demanded by movie makers as the aircraft (V) provides very stable flight, carrying heavy professional cameras and extra batteries. 3D geometric customization would enable to have combinations of hardware to be employed by the aircraft (V).

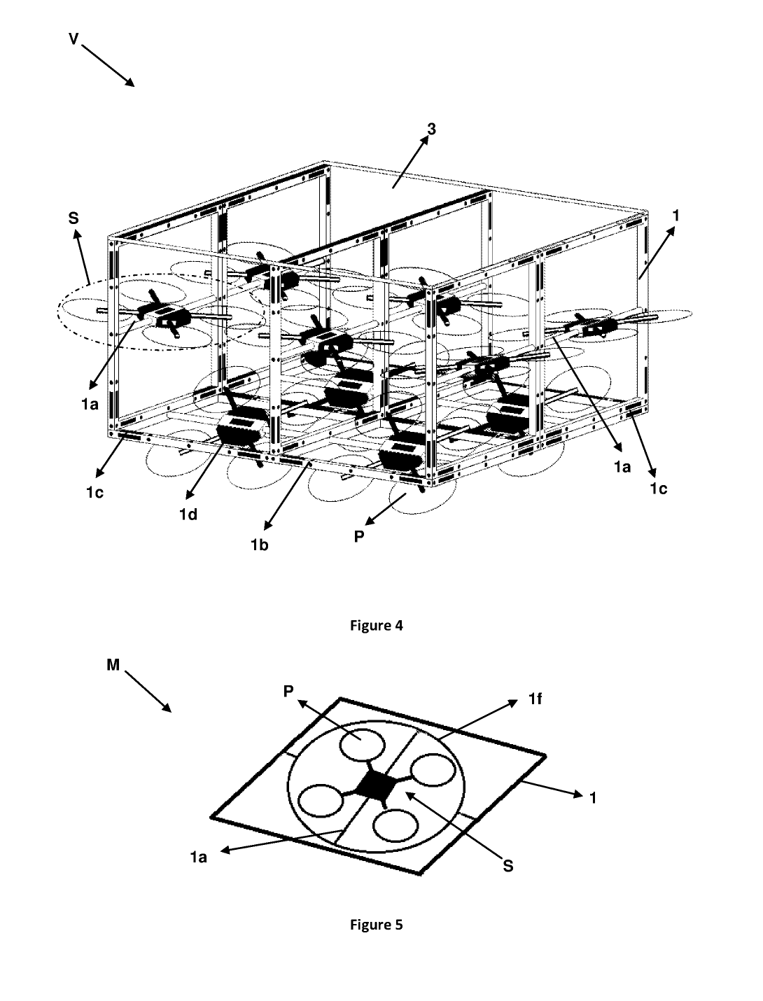

Another application of the invention is shown in FIG. 4. The aircraft (V) has six vertically aligned and four horizontally aligned modules (M) that form an overall cubical structure. In this configuration, the propulsion systems (S) can rotate in orthogonal directions or only in a specified direction which can be defined by using single or multi-axis axis central pieces (1a) acting on two planes in the 3D space. The horizontally and vertically aligned modules help the aircraft to maneuver. FIG. 4 also shows at least one plate (3) located at the top of the modules (M) and closing the whole assembly. The plate(3) can be utilized to carry large objects at different positions sitting on the top. For example, a person can be saved in an emergency operation where the person can jump over the plate (3) which is supported by the propulsion systems (S). Even though the weight of the object is far from the center of gravity of the aircraft creating an unbalancing torque for the aircraft (V), the propulsion systems (S) can roll along the central pieces (1a) and adjust the thrusts which provides a distributed vector thrusting throughout the aircraft that cancels out any unbalanced torques. The balancing actions of the propulsion systems (S) can keep the whole propulsion system or plate (3) in a fixed (e.g. horizontal) position under unbalanced dynamic conditions.

An alternative application of the aircraft (V) includes at least one energy resource (1d) which provides power to the all propulsion systems (S). Sharing the resources enables a need-based energy distribution among the modules (M), where hard working modules (M) drains higher energy. This also enables a fail-safe solution for the batteries of which single failure does not lead to a catastrophic failure of the whole aircraft (V). Furthermore, the optimized usage of the restricted resources increases the overall flight range of the aircraft (V). Conversely, a single energy resource (1d) can provide energy to all of the modules (M) in an assembled aircraft (V). In this case, a larger battery can be protected inside the aircraft (V) while the outside propulsion systems (S) flies the aircraft (V), which can be lighter. The central piece (1a) is, therefore, expected to transfer the electricity as well. The power should be transferred via central piece(1a), then via its electrical connection region (1c) and the power transmission region (1c) of the other module (M) or hardware (2). The information sharing and the control of the whole propulsion system is kept aside of this invention because there are numerous solutions to control the drones in synchronized way.

Another alternative application of the invention provided in FIG. 5 presents an aircraft (V) in which the propulsion system (S) is connected to the circumferential frame (1) via a central piece (1a) and at least one additional piece (1f). This additional piece (1f) frees the other axes of rotations on the top of the original rotation axis provided by the central piece (1a). Hence, the propulsion system (S) can freely rotate along more than one axis relative to the circumferential frame(1). In this application, the additional piece (1f) should not interfere with the propellers (P) such that the components should never clash with the other parts during the rotations. A similar application would be to connect the propulsion system (S) to the central piece (1a) and additional piece (1f) over a spherical joint, which overall allows 360 rotation around all three Cartesian axes. These connections can be found in the conventional propulsion systems that do not require detailed explanation. However, the important point is to allow the propulsion system (S) to rotate around a predefined axis which can be a type of customization to the propulsion system or more than one axes. Noting that, more the rotating piece, it's harder to sustain the electrical connectivity that should also be considered by the operator.

A preferred application of the invention has at least one electrical connection region (1c) and at least one assembly region (1b) which are in close vicinity to each other that allows easier and safer electrical and physical connections between the modules (M). The physical assembly of the aircraft (V) can be also performed by conventional fasteners suitable to withstand the loads occurring during the flight. The propulsion systems (S) include flight computers (not shown in the figures) that operate the aircraft (V) in synchronization. The computer can understand the modular configuration of the aircraft (V) and includes different mission definitions that handle the synchronization. In this case, the computer on one of the modules (M) or each can take its defined roles that harmonizes the individual propulsion system (S) behavior. Besides, the mission characteristics, such as surveying, transportation or emergency tasks, would be also defined in the software of the computers that apply the required characteristic behaviors. The key part in the control of the invention is that each propulsion system (S) is expected to have its own computer that is also used for coordinating and harmonizing the actions of each propulsion system (S) forming the aircraft (V) controlled automatically or remotely by a human operator.

One of the most important features of the invented aircraft (V) is the formation of three-dimensional structural box propulsion system made of circumferential frames (1). An application of the concept can be achieved by using a polygonal shape for the circumferential frame (1). The aircraft (V) shown in FIG. 2 forms a box structure propulsion system formed by many modules (M), where each has square shaped circumferential frames (1). Box structures are widely used in aerospace and civil engineering designs due to its superior load carrying capacity within a lightweight and simple solution. In a heavy-duty transportation mission, the aircraft (V) would have adequate stiffness and rigidity within the lightest weight, a vital feature for all flying vehicles, that would allow higher load carrying capacity and range. As mentioned in the previous chapters, the truss propulsion system in the box structure cancels out the secondary internal loads induced inside the aircraft (V). Moreover, some of the internal loads can be kept away from the propulsion systems (S) because the major load flows are handled by the relatively stiff cage propulsion system made of circumferential frames (1). The central piece (1a) should possess enough tolerance at the connection point with the circumferential frame (1), which helps to reduce the transfer of the loads along the rotation axis as the controlled looseness keeps some translational loads away from the propulsion system (S). On the other hand, the propulsion system (S) continue providing operational loads in the thrust direction or the inertial forces due to the conservation of angular momentum to the aircraft via rotational piece (1a) and then circumferential frame (1) while the propulsion system (S) can freely rotate around the rotational piece (1a). In short, the scalable box propulsion system achieved by the invention provides a scalable, lightweight solution for heavy load transportation missions.

If the distance between the propulsion systems (S) in the aircraft (v) is too short, the aerodynamics at the adjacent propulsion systems (A) under downwash will have a reduced thrust efficiency and may yield vibrations. The distance between the propulsion systems (S) should also concern this effect of inter-modular aerodynamic effect. This distance also determines the size of the circumferential frame (1), and therefore, the weight of the overall aircraft (V). Hence, it becomes an optimization problem where the distance between the modules should be kept as large as possible while not yielding an over-weight solution. The distance is mainly a function of exiting air velocity and diameter of the propellers (P) and should be determined for each design case.

In the invention, each propulsion system (S) in the aircraft (V) is capable of performing a stable flight on its own. This feature highly enhances the safety of the aircraft (V) since a loss of a constituent propulsion system (S) does not directly lead to a catastrophic failure of the whole assembly. This is due to the fact that the invented aircraft (V) is made of stable propulsion systems of which superposition leads to a stable propulsion system. This feature also opens the way to build relatively random shapes, including many asymmetric shapes, in designing the overall aircraft (V). Using stable propulsion systems also enhances the maneuverability of the aircraft (V) due to having more options while customizing the aircraft (V) design.

1-34. (canceled)

35. An aircraft (V) comprising at least two modules (M), each module (M) comprising a propulsion system (S); where each propulsion system (S) is suitable to be controlled remotely, able to perform vertical take-off, flight, and landing, and said aircraft (V) comprising at least one thrust provider operating in coordination with these propulsion systems (S), characterized in that;
the said propulsion system (S) comprises at least two propellers (P);
each module (M) comprises a polygon shaped circumferential frame (1),
said circumferential frame (1) comprises at least one central piece (1a) rotatably mounted to two facing sides of the circumferential frame (1) and supporting the propulsion system (S) in the center of the circumferential frame (1) for providing independent rotation of the propulsion system (S) with respect to the frame (1), and characterized by;
at least two assembly regions (1b) that face outside of the said circumferential frame (1) to physically attach at least two adjacent modules (M)
at least two electrical connection regions (1c) that face outside of the said circumferential frame (1) to electrically connect at least two adjacent modules (M), which enables at least one power source (1d) to be shared among modules (M).

36. An aircraft (V) of claim 35, wherein the power source (1d) includes at least one battery and/or gyroscope and/or a control computer.

37. An aircraft (V) of claim 35, wherein said thrust provider is a motor which is connected to the power source (1d).

38. An aircraft (V) of claim 35, wherein the individual self-flight capable module (M) includes at least two propellers (P) which are connected to each other via at least one propeller beam (S1), which propeller beam (S1) reaches the center of the propeller (P).

39. An aircraft (V) of claim 36, wherein the system (S) encompasses four propellers (P) which are located at the corners of a polygon of which center houses the power source (1d).

40. An aircraft (V) of claim 35, wherein at least one secondary power transmission region (1e) is located at the outside of the module (M) that allows attaching a hardware (2).

41. An aircraft (V) of claim 35, wherein the power source (1d) is connected to the rotational piece (1a).

42. An aircraft (V) of claim 35, wherein the information is transmitted to the adjacent Modules (M) or hardware (2) wireless or directly via the secondary power transmission region (1e).

43. An aircraft (V) of claim 35, wherein the propulsion system (S) is connected to the circumferential frame (1) via at least one circular or polygon shaped additional piece (1f) which is able to rotate around an axis relative to central piece (1a).

44. An aircraft (V) of claim 35, wherein the propellers (P) stay inside of the additional piece (1f).

45. An aircraft (V) of claim 35, wherein the assembly region (1b) has a mating hole and a structure which is suitable to be attached to the assembly region (1b) of the next module (M).

46. An aircraft (V) of claim 35, wherein the module (M) has at least one control unit capable of performing synchronized thrust vectoring in order to control the whole aircraft (V).

47. An aircraft (V) of claim 35, wherein the whole set of circumferential frames (1) after the assembly of modules (M) form a three-dimensional cage structure.
